(19) United States
(12) Patent Application Publication
(10) Pub. No.: US 2016/0212092 A1
(43) Pub. Date: Jul. 21, 2016

(54) RESPONSE DEVICE, INFORMATION PROCESSING DEVICE, RESPONSE METHOD, INFORMATION PROCESSING METHOD, AND NON-TRANSITORY COMPUTER READABLE MEDIUM

(71) Applicant: FUJI XEROX CO., LTD., Tokyo (JP)

(72) Inventors: Yuichi KAWATA, Kanagawa (JP); Hisaji HIRAMATSU, Kanagawa (JP); Kei HATANO, Kanagawa (JP); Tadamasa SAKAMAKI, Kanagawa (JP); Takanori FUKUOKA, Kanagawa (JP)

(73) Assignee: FUJI XEROX CO., LTD., Tokyo (JP)

(21) Appl. No.: 14/842,455

(22) Filed: Sep. 1, 2015

(30) Foreign Application Priority Data
Jan. 21, 2015 (JP) 2015-009369

(51) Int. Cl. H04L 29/12; H04L 12/931

(52) U.S. Cl. CPC H04L 61/103; H04L 49/40; H04L 61/6022

(57) ABSTRACT

A response device includes a memory, a reception unit, and a response unit. The memory stores a logical address and a physical address in a communication circuit which are assigned to an external information processing device connected to the communication circuit that is the same as a communication circuit to which the response device is connected. The reception unit receives an address request for requesting a physical address from the communication circuit. The response unit responds with the stored physical address of the information processing device in a case where a destination address of the received address request is equal to the stored logical address of the information processing device.

### CROSS-REFERENCE TO RELATED APPLICATIONS

This application is based on and claims priority under 35 USC 119 from Japanese Patent Application No. 2015-009369 filed Jan. 21, 2015.

### BACKGROUND

### Technical Field

The present invention relates to a response device, an information processing device, a response method, an information processing method, and a non-transitory computer readable medium.

### SUMMARY

According to an aspect of the invention, there is provided a response device including a memory, a reception unit, and a response unit. The memory stores a logical address and a physical address in a communication circuit which are assigned to an external information processing device connected to the communication circuit that is the same as a communication circuit to which the response device is connected. The reception unit receives an address request for requesting a physical address from the communication circuit. The response unit responds with the stored physical address of the information processing device in a case where a destination address of the received address request is equal to the stored logical address of the information processing device.

### BRIEF DESCRIPTION OF THE DRAWINGS

Exemplary embodiments of the present invention will be described in detail based on the following figures, wherein:

FIG. 1 is a diagram illustrating an overall configuration of a subnet according to a first exemplary embodiment of the present invention;

FIG. 2 is a block diagram illustrating a hardware configuration of a response server according to the first exemplary embodiment;

FIG. 3 is a diagram illustrating a configuration of an address management table according to the first exemplary embodiment;

FIG. 4 is a block diagram illustrating a functional configuration of a communication controller of a network controller according to the first exemplary embodiment;

FIG. 5 is a block diagram illustrating a hardware configuration of a client device according to the first exemplary embodiment;

FIG. 6 is a sequence diagram illustrating a process for address resolution according to the first exemplary embodiment;

FIGS. 7A and 7B are diagrams each illustrating a configuration of a MAC address table which is stored in a switching hub;

FIG. 8 is a block diagram illustrating a functional configuration of a subnet according to a second exemplary embodiment of the present invention; and

FIG. 9 is a sequence diagram illustrating a process for a request for a response to an ARP request packet according to the second exemplary embodiment.

### DETAILED DESCRIPTION

Exemplary embodiments of the present invention will be described below with reference to the drawings.

### First Exemplary Embodiment

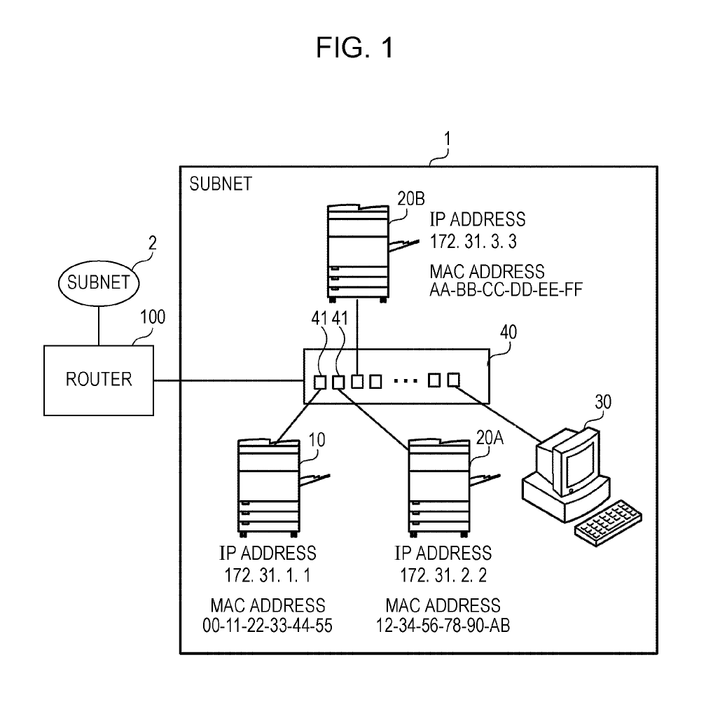

FIG. 1 is a diagram illustrating an overall configuration of a subnet 1 according to a first exemplary embodiment of the present invention. As illustrated in FIG. 1, the subnet 1 includes computer devices including a response server 10, multiple client devices 20 (20A and 20B), a personal computer (PC) 30, and a switching hub 40. In the subnet 1, a communication circuit is configured by a local area network (LAN) that performs communication conforming to Ethernet® standards. In the subnet 1, communication is performed based on various protocols including a transmission control protocol (TCP)/Internet protocol (IP). In this case, the network address of the subnet 1 is “172.31.0.0”. Furthermore, as a subnet mask, “255.255.0.0” is set for each device in the subnet 1.

The switching hub 40 is a known switching hub which stores a media access control (MAC) address table. The switching hub 40 is a connection device which includes multiple physical ports (connection terminals) 41 each of which is connected to an external communication device. The switching hub 40 learns a MAC address which is assigned to a device connected to each of the physical ports 41, and manages a port number of the physical port 41 and the MAC address in association with each other in the MAC address table. The MAC address is an example of a physical address according to an exemplary embodiment of the present invention, and is address information unique to each device. The response server 10, the multiple client devices 20, and the PC 30 are mutually connected via the communication circuit including the switching hub 40. Furthermore, the switching hub 40 is connected to another subnet 2 via a router 100. The router 100 is a known router (relay device) that allows connection between the subnet 1 and the subnet 2.

The response server 10 is an example of a response device according to an exemplary embodiment of the present invention, and is a server device which has a function for resolving the MAC address of the client devices 20. Specifically, in the case where the destination address of a received address resolution protocol (ARP) request packet is equal to the IP address of a client device 20, the response server 10 responds with the MAC address of the client device 20. The ARP request packet is an example of an address request according to an exemplary embodiment of the present invention. The IP address is an example of a logical address according to an exemplary embodiment of the present invention, and is address information which is assigned to each of the devices within the subnet 1 such that the addresses do not overlap each other. In this case, the IP address of the response server 10 is “172.31.1.1”, and the MAC address of the response server 10 is “00-11-22-33-44-55”. Furthermore, the response server 10 has a function for performing information processing in accordance with an instruction from an external device including the PC 30. The response server 10 performs, for example, information processing such as copying, scanning, and facsimile transmission.

Each of the client devices 20 is an example of an information processing device according to an exemplary embodiment of the present invention, and has a function for performing information processing in accordance with an instruction from an external device including the PC 30. Similar to the response server 10, the client devices 20 perform, for example, information processing such as copying, scanning, and facsimile transmission. In this case, the IP address of the client device 20A is “172.31.2.2”, and the MAC address of the client device 20A is “12-34-56-78-90-AB.” The IP address of the client device 20B is “172.31.3.3” and the MAC address of the client device 20B is “AA-BB-CC-DD-EE-FF”. Since the response server 10 and the multiple client devices 20 belong to the same subnet 1, network parts, each of which is part of an IP address, are the same.

The PC 30 has a function for instructing external devices including the response server 10 and the multiple client devices 20 to perform information processing.

In this case, although only one response server 10 is located inside the subnet 1, two or more response servers 10 may exist. Furthermore, although the two client devices 20A and 20B are illustrated as the client devices 20 in FIG. 1, only one or three or more client devices 20 may exist.

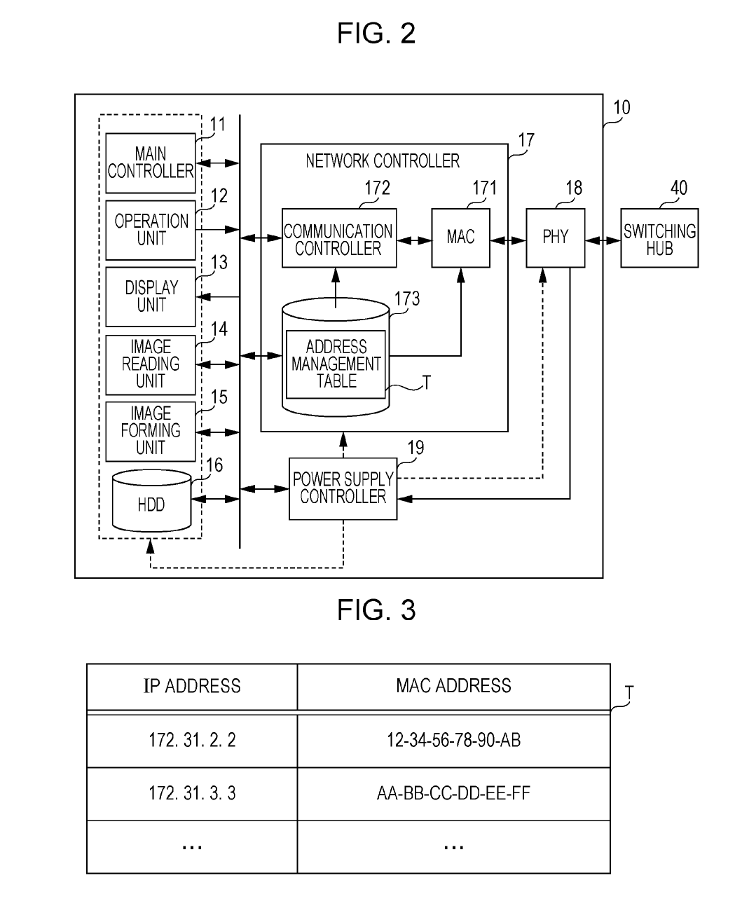

FIG. 2 is a block diagram illustrating a hardware configuration of the response server 10. In FIG. 2 and FIG. 5, which will be described later, solid arrows indicate flows of signals and broken arrows indicate flows of electric power. As illustrated in FIG. 2, the response server 10 includes a main controller 11, an operation unit 12, a display unit 13, an image reading unit 14, an image forming unit 15, a hard disk drive (HDD) 16, a network controller 17, a physical layer (PHY) 18, and a power supply controller 19.

The main controller 11 is a control device which controls the entire response server 10. The main controller 11 includes a processor which includes a main central processing unit (CPU) as an arithmetic processing device, a random access memory (RAM) as a work memory, and a read only memory (ROM). The main CPU controls each unit of the response server 10 by reading a program stored in the ROM or the HDD 16 onto the RAM and executing the program.

The operation unit 12 is an operation device which receives an operation performed by a user. The operation unit 12 includes, for example, a touch screen provided overlapping with the display surface of the display unit 13, and a physical key. The display unit 13 is, for example, a liquid crystal display which displays various images (screens) on the display surface for displaying an image, and notifies the user of information. The image reading unit 14 is, for example, a scanner which reads an image of an original and generates image data representing the read image. The image forming unit 15 is, for example, a printer which forms an image on a medium such as paper by an electrophotographic process. The HDD 16 is a storage device which stores data such as a program executed by the main controller 11.

The network controller 17 functions as a communication control device which communicates with an external device via the PHY 18 which manages processing of a physical layer of an open systems interconnection (OSI) reference model. The network controller 17 includes a media access controller (MAC) 171, a communication controller 172, and a memory 173.

The MAC 171 is a media access controller which manages processing related to a lower sublayer of a data link layer of the OSI reference model and performs communication via the PHY 18. The MAC 171 is an example of a reception unit according to an exemplary embodiment of the present invention, and receives data (packet) which has arrived from the switching hub 40. The MAC 171 extracts only a packet which is necessary for the response server 10, and outputs the extracted packet to the communication controller 172. The MAC 171 outputs to the communication controller 172, in addition to the packet addressed to the response server 10, an ARP request packet addressed to the client devices 20, based on an address management table T which is stored in the memory 173.

The communication controller 172 controls the network controller 17. The communication controller 172 includes a sub-CPU as an arithmetic processing device and a RAM as a work memory, and controls each unit of the network controller 17. The communication controller 172 has a function for processing a packet received by the MAC 171.

The memory 173 is an example of a memory according to an exemplary embodiment of the present invention, and is a semiconductor memory (for example, a nonvolatile memory) which stores the address management table T.

FIG. 3 is a diagram illustrating a configuration of the address management table T. As illustrated in FIG. 3, the address management table T is a table in which an IP address and a MAC address which are assigned to each of the client devices 20 are registered in the same record for the client device 20. In the example of FIG. 3, the IP address and the MAC address of each of the client devices 20A and 20B are registered with the address management table T in association with each other.

The IP addresses and the MAC addresses in the address management table T are registered by the main controller 11, for example, in accordance with an operation performed by a user on the operation unit 12.

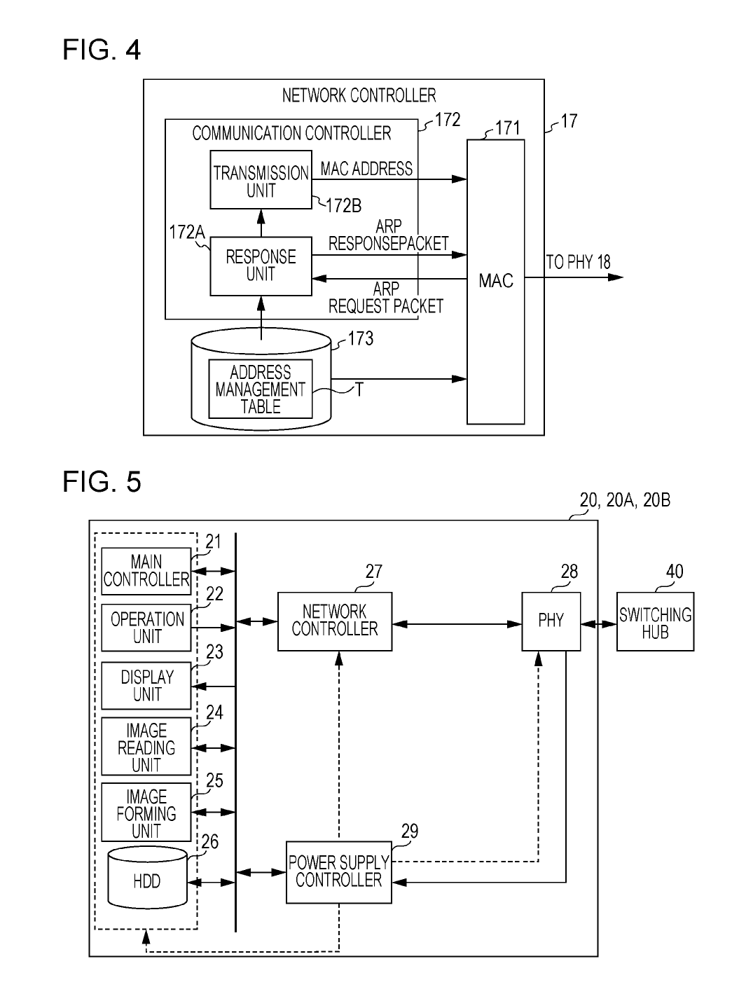

FIG. 4 is a block diagram illustrating a functional configuration of the network controller 17. As illustrated in FIG. 4, the communication controller 172 implements functions corresponding to a response unit 172A and a transmission unit 172B.

When receiving an ARP request packet whose destination address is equal to the IP address of the response server 10, the MAC 171 supplies the ARP request packet to the response unit 172A. Furthermore, when receiving an ARP request packet whose destination address is equal to the IP address of a client device 20 which is registered with the address management table T, the MAC 171 supplies the ARP request packet to the response unit 172A.

The response unit 172A is an example of a response unit according to an exemplary embodiment of the present invention, and responds with a MAC address to the ARP request packet received by the MAC 171. Specifically, in response to the ARP request packet whose destination address is equal to the IP address of the response server 10, the response unit 172A transmits the ARP response packet including the MAC address of the response server 10 to the switching hub 40 via the MAC 171 and the PHY 18. Furthermore, in response to the ARP request packet whose destination address is equal to the IP address of a client device 20, the response unit 172A transmits the MAC address of the client device 20 which is registered with the address management table T to the switching hub 40 via the MAC 171 and the PHY 18.

The transmission unit 172B is an example of a transmission unit according to an exemplary embodiment of the present invention. When a response with the MAC address of a client device 20 is made by the response unit 172A, after this response (that is, after an ARP response packet is transmitted), the transmission unit 172B transmits the MAC address of the response server 10 to the switching hub 40 via the MAC 171 and the PHY 18. When a response with the MAC address of the response server 10 is made by the response unit 172A, the transmission unit 172B does not transmit the MAC address of the response server 10.

Explanation will be provided with reference to FIG. 2 again.

The power supply controller 19 is an example of a power supply controller according to an exemplary embodiment of the present invention, and controls supply of power (electric power) of the response server 10. The power supply controller 19 has a function of power management and controls the supply of power to each unit of the response server 10, based on one of a “normal mode” and a “power-saving mode”. The normal mode is an example of a first mode according to an exemplary embodiment of the present invention, and is a mode in which power is supplied to all the hardware circuits of the response server 10 explained with reference to FIG. 2. The power-saving mode is an example of a second mode according to an exemplary embodiment of the present invention, and is a mode in which supply of power to part of the hardware circuits of the response server 10 explained with reference to FIG. 2 is stopped and the power consumption of the response server 10 is reduced. In the case of the power-saving mode, the power supply controller 19 stops supply of power to the main controller 11, the operation unit 12, the display unit 13, the image reading unit 14, the image forming unit 15, and the HDD 16, and supplies power to the network controller 17 and the PHY 18. That is, the network controller 17 and the PHY 18 operate in both of the normal mode and the power-saving mode.

To the hardware circuits to which power is supplied under the control of the power supply controller 19, an operation clock is supplied by a clock supply circuit, which is not illustrated in FIG. 2.

For example, when the response server 10 is unused continuously for a predetermined period of time in the normal mode (for example, when there is no operation on the operation unit 12 or information processing is not executed), the main controller 11 controls the power supply controller 19 to allow transition from the normal mode to the power-saving mode. Furthermore, for example, when the use of the response server 10 starts in the power-saving mode (for example, when there is an operation on the operation unit 12 or a specific packet is received by the network controller 17), the power supply controller 19 allows transition from the power-saving mode to the normal mode and supplies power. The power supply controller 19 allows transition from the power-saving mode to the normal mode, for example, when an activation request packet (for example, a magic packet) for requesting activation of the response server 10, based on a Wake On LAN function, is received. The magic packet is a packet which includes data in which the MAC address of a device to be activated is repeated 16 times. Furthermore, the power supply controller 19 notifies the main controller 11 of transition to the normal mode.

FIG. 5 is a block diagram illustrating a hardware configuration of the client devices 20. As illustrated in FIG. 5, each of the client devices 20 includes a main controller 21, an operation unit 22, a display unit 23, an image reading unit 24, an image forming unit 25, an HDD 26, a network controller 27, a PHY 28, and a power supply controller 29. Each hardware circuit of the client devices 20 is generally the same as the hardware circuit of the response server 10 with the same name.

However, the client devices 20 do not have a function for responding with the MAC address of other devices to the ARP request packet. Therefore, the network controller 27 of the client devices 20 does not store a table which corresponds to the address management table T.

Furthermore, in the case where a client device 20 is in the power-saving mode, the power supply controller 29 stops supply of power to the main controller 21, the operation unit 22, the display unit 23, the image reading unit 24, the image forming unit 25, the HDD 26, and the network controller 27, and supplies power to the PHY 28. That is, the network controller 27 does not operate in the power-saving mode, whereas the PHY 28 operates in both of the normal mode and the power-saving mode.

The network controller 27 is an example of a communication controller according to an exemplary embodiment of the present invention.

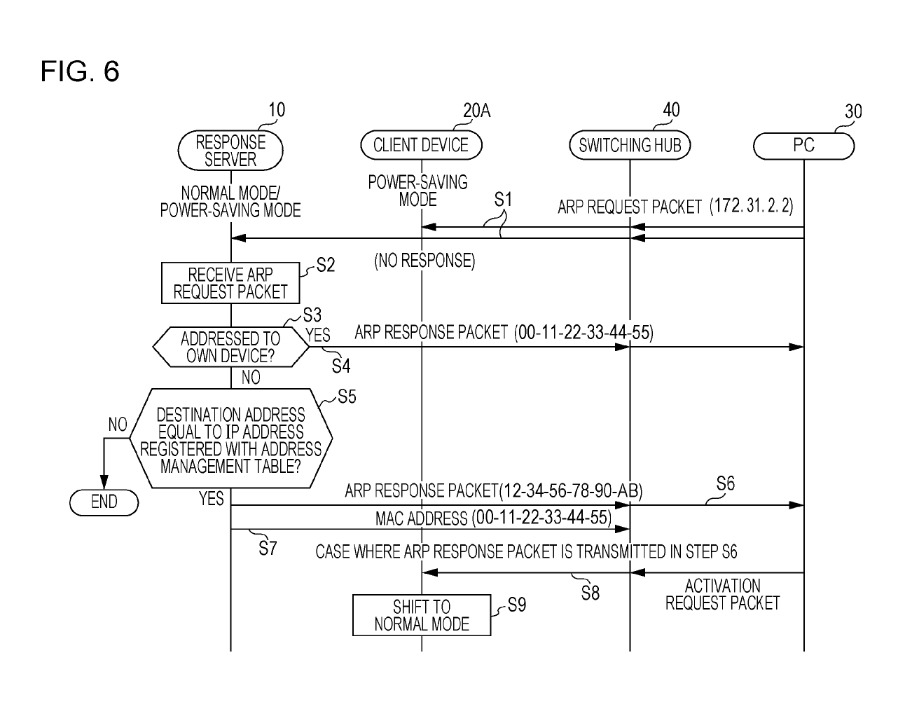

FIG. 6 is a sequence diagram illustrating a process for address resolution executed in the subnet 1. Before operations described below are performed, the client device 20A operates in the power-saving mode, and the response server 10 operates in either the normal mode or the power-saving mode.

For instructing the client device 20A to execute information processing, the PC 30 first broadcasts ARP request packets within the subnet 1 (step S1). It is assumed that, “172.31.2.2”, which is the IP address of the client device 20A, is specified in the ARP request packets as the destination address. The ARP request packets reach the response server 10 and the client devices 20A and 20B, for which the network part of the IP address is “172.31.”.

Since the network controller 27 stops operating, the client device 20A does not respond to the ARP request packet which has arrived at the client device 20A. Although not illustrated in FIG. 6, if the client device 20B operates in the normal mode, since the ARP request packet is not addressed to the client device 20B, the client device 20B discards the ARP request packet. The network controller 17 of the response server 10 operates both in the normal mode and the power-saving mode. Therefore, the network controller 17 of the response server 10 receives the ARP request packet which has arrived at the response server 10 (step S2).

Next, the network controller 17 determines whether or not the received ARP request packet is addressed to the response server 10 (step S3). In this case, since the destination address of the ARP request packet is equal to the IP address of the client device 20A, the network controller 17 obtains a determination result “NO” in step S3.

If the destination address of the ARP request packet is “172.31.1.1”, which is the IP address of the response server 10, the network controller 17 obtains a determination result “YES” in step S3. Then, the network controller 17 responds with “00-11-22-33-44-55”, which is the MAC address of the response server 10 (step S4). In this case, subsequently, communication for executing information processing is preformed between the PC 30 and the response server 10.

When a determination result “NO” is obtained in step S3, the network controller 17 determines whether or not the destination address of the ARP request packet is equal to an IP address registered with the address management table T (step S5).

In this case, the network controller 17 obtains a determination result “YES” in step S5. Then, the network controller 17 transmits to the switching hub 40 (then, to the PC 30) an ARP response packet which includes the MAC address registered with the address management table T in association with the destination address (IP address) of the ARP request (step S6). Thus, the network controller 17 responds with the MAC address of the client device 20A to the PC 30 which is the transmission source of the ARP request packet. In the ARP response packet, “12-34-56-78-90-AB” is included as the MAC address.

After transmitting the ARP response packet in step S6, the network controller 17 transmits the MAC address of the response server 10 to the switching hub 40 (step S7). For example, after transmitting the ARP request packet in step S6, the network controller 17 transmits a packet which includes the MAC address of the response server 10. The MAC address transmitted in step S7 is “00-11-22-33-44-55”.

When the network controller 17 obtains a determination result “NO” in step S5, the network controller 17 discards the received ARP request packet.

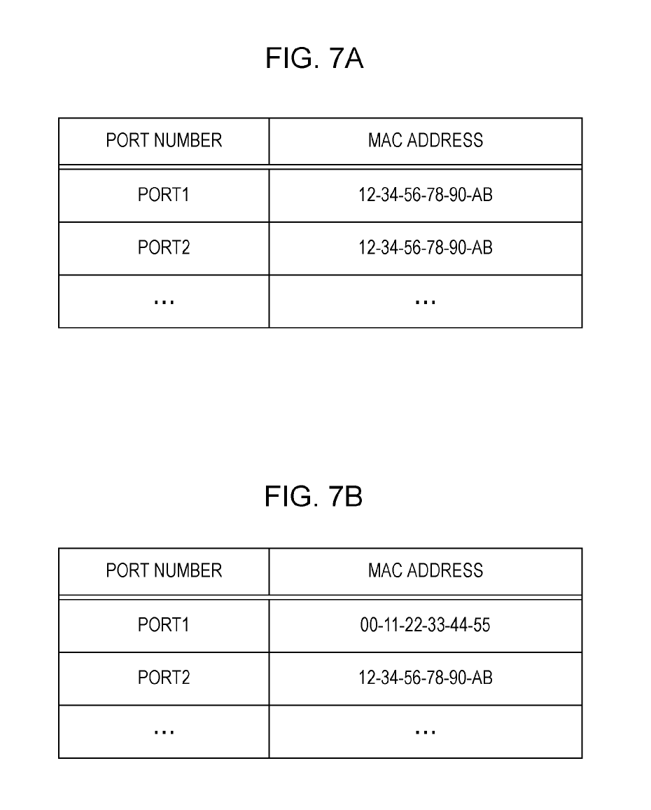

A reason why the response server 10 transmits the MAC address in step S7 will be explained with reference to FIGS. 7A and 7B.

By the processing of step S6, at the switching hub 40, the MAC address of the client device 20A is transmitted through the physical port 41 to which the response server 10 is connected (let a port number be “PORT 1”). In this case, as illustrated in FIG. 7A, the MAC address of the client device 20A may be registered with the MAC address table of the switching hub 40 in association with the port number “PORT 1”. Therefore, the MAC address of the client device 20A is registered redundantly for the physical port 41 of the port number “PORT 1” and the physical port 41 of the port number “PORT 2” to which the client device 20A is connected, and the MAC address of the response server 10 is deleted from the MAC address table. Therefore, in the case where a packet whose destination address is equal to the MAC address of the response server 10 is transmitted later at the switching hub 40, flooding occurs in the switching hub 40. Due to the flooding, the arrival of a packet at the response server 10 may be delayed or the load of communication at the subnet 1 may increase.

In contrast, in the case where the MAC address is transmitted in step S7, after the MAC address of the client device 20A is transmitted through the physical port 41 of the port number “PORT 1”, the MAC address of the response server 10 is transmitted. Therefore, as illustrated in FIG. 7B, the MAC address of the response server 10 is registered with the MAC address table in association with the port number “PORT 1”. In this case, the above-mentioned flooding does not occur. Therefore, delay in the arrival of a packet at the response server 10 and an increase in the load of communication at the subnet may be suppressed.

Explanation will be provided with reference to FIG. 6 again.

When receiving the ARP response packet transmitted in step S6, the PC 30 transmits an activation request packet (in this case, a magic packet) to the switching hub 40 (then, to the client device 20A), based on the MAC address of the client device 20A included in the ARP response packet (step S8). This activation request packet reaches the client device 20 via the switching hub 40.

At the client device 20A, when detecting that the activation request packet has arrived from the switching hub 40, the PHY 28 notifies the power supply controller 29 of the arrival of the activation request packet. The PHY 28 has a function, for example, for determining whether or not the packet is an activation request packet including the MAC address of the client device 20A. In response to the notification of the arrival of the activation request packet, the power supply controller 29 performs control for allowing transition of the response server 10 from the power-saving mode to the normal mode (step S9).

When the transition of the client device 20A to the normal mode is completed, communication for executing information processing is performed between the PC 30 and the client device 20A.

In the subnet 1, as described above, even in the case where the client device 20 does not respond to the ARP request packet which has arrived at the client device 20, control to be performed after the response is made proceeds. For example, not only in the case where the client device 20 operates in the power-saving mode and thus does not respond to the ARP request packet, but also in the case where a response to the ARP request packet is delayed (that is, it takes long time to respond), a situation in which control to be performed after the ARP response is made is not performed due to timeout may be suppressed. Furthermore, in the subnet 1, an ARP request packet addressed to the client device 20 is received by the response server 10. Therefore, compared to the case where a packet is transferred between the PC 30 and the client device 20, reception by the response server 10 may suppress an increase in the load of communication in the subnet 1.

Furthermore, the client device 20 does not need to operate a hardware circuit for responding to an ARP request packet in the power-saving mode, thereby power-saving effects being increased. For example, in the case where a large number of client devices 20 exist, power-saving effects for the entire subnet 1 are expected. Furthermore, the response server 10 responds to an ARP request packet when the response server 10 operates in any one of the normal mode and the power-saving mode, and therefore control to be performed after the respond is made proceeds.

Furthermore, although the PC 30 and the response server 10 are located in the same subnet in the above description, the PC 30 may be located in a different subnet such as the subnet 2. In this case, if the destination address of an ARP request packet is equal to the IP address of a device located within the subnet 1, the ARP request packet is transmitted in the subnet 1 via the router 100. Therefore, the MAC address of the client device 20 is resolved by the process explained with reference to FIG. 6.

### Second Exemplary Embodiment

In the first exemplary embodiment described above, when the client device 20 is in the normal mode, both of the response server 10 and the client device 20 may transmit an ARP response packet. In contrast, in the subnet 1 according to a second exemplary embodiment, only one of the response server 10 and the client device 20 is provided with a function for transmitting an ARP response packet. Specifically, during the period in which the client device 20 does not respond to an ARP request packet, the client device 20 requests the response server 10 to respond to the ARP request packet.

Since each device included in the subnet 1 and the hardware configuration of the device according to the second exemplary embodiment are the same as those in the first exemplary embodiment described above, explanation for the devices and the hardware configurations will be omitted. Furthermore, elements referred to with the same signs as those in the first exemplary embodiment described above function in a manner similar to those in the first exemplary embodiment described above.

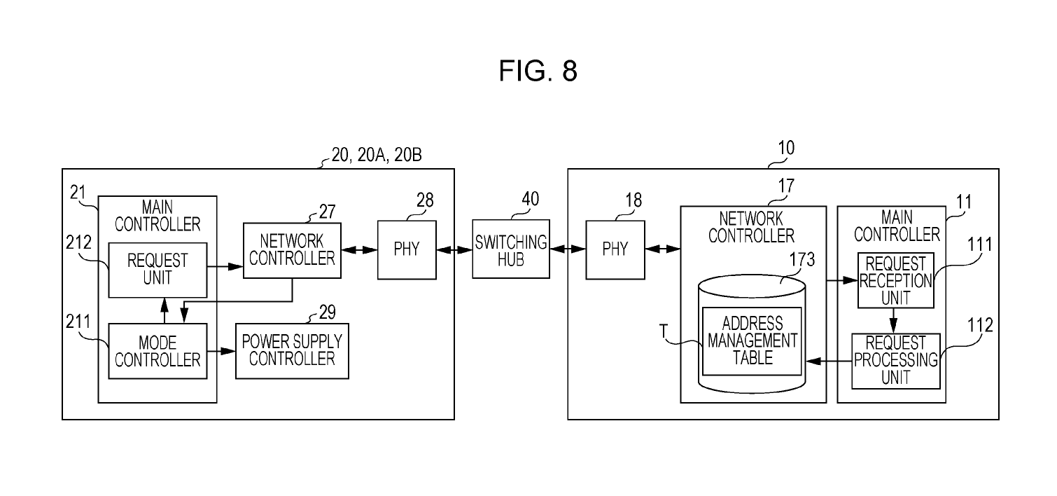

FIG. 8 is a block diagram illustrating the functional configuration of the subnet 1 according to the second exemplary embodiment. As illustrated in FIG. 8, the main controller 21 of the client device 20 implements functions corresponding to a mode controller 211 and a request unit 212.

The mode controller 211 is an example of a mode controller according to an exemplary embodiment of the present invention. The mode controller 211 sets the mode of the client device 20 to the normal mode or the power-saving mode, and controls the power supply controller 29 to supply power in accordance with the set mode. The power supply controller 29 may be controlled in accordance with the mode in a manner similar to that in the first exemplary embodiment described above.

The request unit 212 is an example of a request unit according to an exemplary embodiment of the present invention. In the case where the mode controller 211 allows transition from the normal mode to the power-saving mode, the request unit 212 requests, via the network controller 27 and the PHY 28, the response server 10 to respond to an ARP request packet.

The main controller 11 of the response server 10 implements functions corresponding to a request reception unit 111 and a request processing unit 112.

The request reception unit 111 is an example of a reception unit according to an exemplary embodiment of the present invention, and receives, via the switching hub 40 from the client device 20, a request for a response to an ARP request packet.

The request processing unit 112 is an example of a request processing unit according to an exemplary embodiment of the present invention, and performs processing for updating the address management table T in response to the request received by the request reception unit 111.

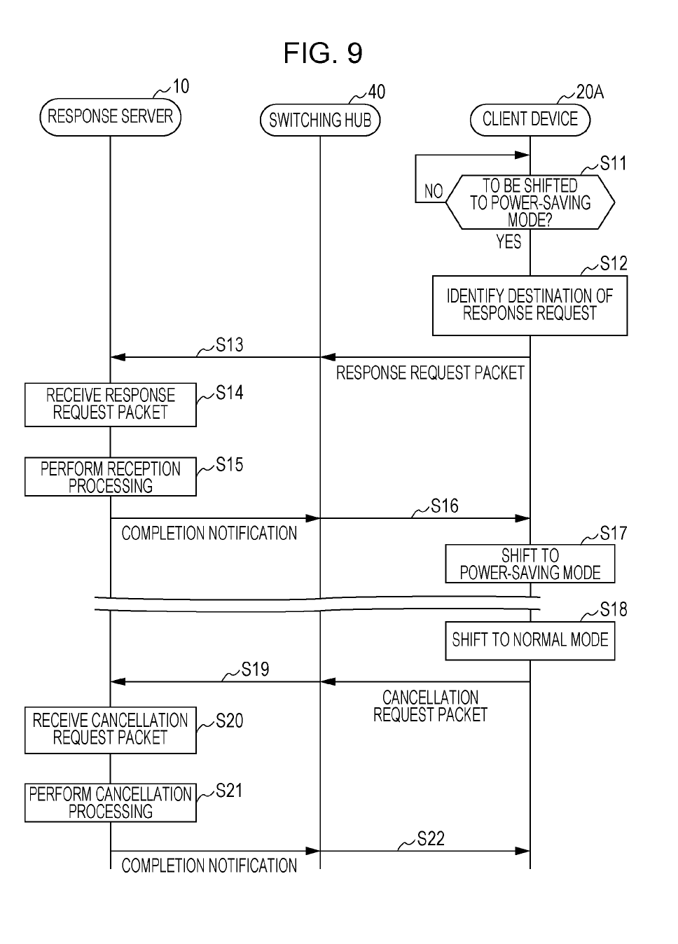

FIG. 9 is a sequence diagram illustrating a process for a request for a response to an ARP request packet performed at the subnet 1. Before operations described below are performed, each of the client device 20A and the response server 10 operates in the normal mode. Furthermore, communication between the client device 20A and the response server 10 is performed via the switching hub 40.

The main controller 21 of the client device 20A determines whether or not transition from the normal mode to the power-saving mode is to be performed (step S11). In this case, the main controller 21 may determine whether or not the conditions for transition from the normal mode to the power-saving mode described in the first exemplary embodiment are satisfied.

When a determination result “YES” is obtained in step S11, the main controller 21 identifies the destination of a request for a response to an ARP request packet (step S12). This request destination may be identified by storing information of the IP address and the MAC address of the response server 10 in advance in the HDD 16 or the like or may be identified by causing the client device 20 to search the subnet 1 for a device as the request destination. In the latter case, search signals for searching for the request destination are broadcast in the subnet 1. A device which has a function for receiving such a request may response to a received search signal. In this case, the main controller 21 identifies the response server 10 as the request destination.

Next, the main controller 21 transmits a response request packet for requesting a response to the ARP request packet to the response server 10 that is identified as the request destination via the network controller 27 and the PHY 28 (step S13). The response request packet includes, for example, the IP address and the MAC address of the client device 20A.

The main controller 11 of the response server 10 receives the response request packet via the PHY 18 and the network controller 17 (step S14), and performs reception processing for receiving the request for a response to the ARP request packet (step S15). Specifically, the main controller 11 registers the IP address and the MAC address that are included in the response request packet in association with each other with the address management table T of the network controller 17.

When the reception processing is completed, the main controller 11 transmits completion notification to the client device 20A via the network controller 17 and the PHY 18 (step S16). Upon receiving the completion notification via the PHY 28 and the network controller 27, the main controller 21 of the client device 20A allows transition from the normal mode to the power-saving mode (step S17). After the transition to the power-saving mode is performed, the response server 10 responds to the ARP request packet in place of the client device 20A, and the client device 20 does not make a response.

After that, the client device 20A is shifted (recovered) from the power-saving mode to the normal mode (step S18). When the transition to the normal mode is performed, the main controller 21 transmits a cancellation request packet for canceling a request to the response server 10 that is identified as the request destination in step S12 via the network controller 27 and the PHY 28 (step S19). In other words, the cancellation request packet is a packet to be transmitted in order to stop the response to the ARP request packet addressed to the client device 20A. The cancellation request packet includes, for example, the IP address and the MAC address of the client device 20A.

The main controller 11 of the response server 10 receives the cancellation request packet via the PHY 18 and the network controller 17 (step S20), and performs cancellation processing for cancelling the request for the response to the ARP request packet (step S21). Specifically, the main controller 11 deletes from the address management table T a recording which includes the IP address and the MAC address included in the cancellation request packet. In step S21, the main controller 11 may cancel the request by performing processing (for example, updating a flag) for invalidating the record including the IP address and the MAC address included in the cancellation request packet.

When the cancellation processing is completed, the main controller 11 transmits completion notification to the client device 20A via the network controller 17 and the PHY 18 (step S22). When receiving the completion notification via the PHY 28 and the network controller 27, the main controller 21 of the client device 20A identifies that the request has been deleted. Accordingly, after the client device 20A is shifted to the normal mode, the response server 10 does not respond to the ARP request packet addressed to the client device 20A but the client device 20 responds to the ARP request packet.

In the subnet 1, as described above, one of the response server 10 and the client device 20 responds to an ARP request packet. Therefore, for example, an increase in the load of communication in the subnet 1 is suppressed.

In the case where registration of an IP address and a MAC address with the address management table T is performed by an operation of the operation unit 12 explained in the first exemplary embodiment described above, a response request packet or a cancellation request packet may include information (for example, the number of a record) for identifying the IP address and the MAC address, instead of the IP address and the MAC address.

Furthermore, the client device 20 may request the response server 10 to respond to an ARP request at a timing different from the timing at which the client device 20 is shifted from the normal mode to the power-saving mode. For example, when an instruction is issued by a user operation on the operation unit 12, the client device 20 may request the response server 10 to respond to the ARP request.

### VARIATIONS

The present invention may be implemented in forms different from the foregoing exemplary embodiments. Furthermore, variations described below may be combined together.

The client device 20 according to the second exemplary embodiment described above may request the response server 10 to respond to an ARP request packet by specifying a period (for example, a period of time) during which the response server 10 is to respond to the ARP request packet. In this case, the main controller 21 of the client device 20 transmits to the response server 10 a response request packet which includes information of the period during which the response server 10 is to respond to the ARP request packet. The period during which the response is to be made is, for example, specified by a user of the client device 20.

Based on the received response request packet, the main controller 11 of the response server 10 registers the information of the period during which a response is to be made to the ARP request packet, in association with the IP address and the MAC address, with the address management table T. When receiving the ARP request addressed to the client device 20, the network controller 17 responds with the MAC address based on the address management table T, in place of the client device 20, on condition that the IP address included in the ARP request packet is registered and the current time is within the period during which a respond is to be made.

According to this variation, the response server 10 responds to the ARP request packet only within a specific period, even without processing for cancelling the request, which is explained in steps S19 to S22, being performed.

The response server 10 according to the second exemplary embodiment described above may search for the client device 20 in the power-saving mode that does not respond to an ARP request from among the client devices 20 within the subnet 1, and may respond to the ARP request, in place of the found client device 20.

Part of the configuration and operation described in the foregoing exemplary embodiments may be omitted.

For example, the response server 10 may not transmit the MAC address of the response server 10 after responding with the MAC address of the client device 20. The response server 10 may not be provided with a function for responding to an ARP request packet in the power-saving mode. In this case, when the response server 10 is in the power-saving mode, power supply to the network controller 17 may be stopped.

The response server 10 may not have a function for changing a mode regarding power control or may have three or more modes regarding power control.

The response server 10 may not have a function for performing information processing in accordance with an instruction from an external device. The response server 10 only needs to have at least a function for responding to an ARP request packet addressed to the client device 20.

In a response device according to an exemplary embodiment of the present invention, a response to an address request for requesting an external information processing device for a physical address may be implemented by a hardware circuit different from a network controller, or a communication control device (for example, a processor) which makes such a response may be provided at an external device in a removable manner.

A communication circuit according to an exemplary embodiment of the present invention is not limited to a communication circuit which uses subnets in units of management or not limited to a LAN which performs communication conforming to the standards of Ethernet. Furthermore, a communication circuit according to an exemplary embodiment of the present invention may be a wired communication circuit, a wireless communication circuit, or a communication circuit formed by a combination of wired and wireless communication circuits.

The individual functions implemented by the network controller 17 and the main controllers 11 and 21 according to the foregoing exemplary embodiments may be implemented by one or multiple hardware circuits, may be implemented by executing one or multiple programs for causing a computer to implement the functions, or may be implemented by combining the above configurations. In the case where the functions of the network controller 17 and the main controllers 11 and 21 are implemented using a program, the program may be stored in a computer-readable recording medium such as a magnetic recording medium (a magnetic tape, a magnetic disk (an HDD, a flexible disk (FD), etc.), an optical recording medium (an optical disc etc.), a magneto-optical recording medium, or a semiconductor memory and provided, or may be distributed through a communication circuit such as the Internet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A response device comprising:
a memory that stores a logical address and a physical address in a communication circuit which are assigned to an external information processing device connected to the communication circuit that is the same as a communication circuit to which the response device is connected;
a reception unit that receives an address request for requesting a physical address from the communication circuit; and
a response unit that responds with the stored physical address of the information processing device in a case where a destination address of the received address request is equal to the stored logical address of the information processing device.

2. The response device according to claim 1, further comprising:
a transmission unit that transmits a physical address which is assigned to the response device to the communication circuit after a response with the physical address of the information processing device is made.

3. The response device according to claim 1, further comprising:
a reception unit that receives a request for a response to the address request from the information processing device via the communication circuit,
wherein the response unit responds with the physical address of the information processing device in a case where the request is received.

4. The response device according to claim 2, further comprising:
a reception unit that receives a request for a response to the address request from the information processing device via the communication circuit,
wherein the response unit responds with the physical address of the information processing device in a case where the request is received.

5. The response device according to claim 1, further comprising:
a power supply controller that controls power supply of the response device, based on a first mode or a second mode which requires a smaller power consumption than the first mode,
wherein in a case where the power is supplied based on any one of the first mode and the second mode, the response unit responds with the physical address of the information processing device.

6. The response device according to claim 2, further comprising:
a power supply controller that controls power supply of the response device, based on a first mode or a second mode which requires a smaller power consumption than the first mode,
wherein in a case where the power is supplied based on any one of the first mode and the second mode, the response unit responds with the physical address of the information processing device.

7. The response device according to claim 3, further comprising:
a power supply controller that controls power supply of the response device, based on a first mode or a second mode which requires a smaller power consumption than the first mode,
wherein in a case where the power is supplied based on any one of the first mode and the second mode, the response unit responds with the physical address of the information processing device.

8. The response device according to claim 4, further comprising:
a power supply controller that controls power supply of the response device, based on a first mode or a second mode which requires a smaller power consumption than the first mode,
wherein in a case where the power is supplied based on any one of the first mode and the second mode, the response unit responds with the physical address of the information processing device.

9. An information processing device comprising:
a communication controller that controls communication with a response device which responds to an address request for requesting a physical address, the response device being connected to a communication circuit that is the same as a communication circuit to which the information processing device is connected;
a power supply controller that controls power supply of the information processing device, based on a first mode or a second mode which requires a smaller power consumption than the first mode; and
a request unit that requests, in a case where the information processing device is shifted from the first mode to the second mode, the response device via the communication controller to respond with a physical address assigned to the information processing device to the address request whose destination address is equal to a logical address in the communication circuit assigned to the information processing device.

10. The information processing device according to claim 9,
wherein in a case where the power is supplied based on the second mode, the communication controller does not respond to the address request, and
wherein in a case where a request for activation using the physical address assigned to the information processing device has arrived from the communication circuit, the power supply controller shifts the information processing device from the second mode to the first mode.

11. A response method comprising:
storing a logical address and a physical address in a communication circuit which are assigned to an external information processing device connected to the communication circuit that is the same as a communication circuit to which a response device is connected;
receiving an address request for requesting a physical address from the communication circuit; and
responding with the stored physical address of the information processing device in a case where a destination address of the received address request is equal to the stored logical address of the information processing device.

12. An information processing method comprising:
controlling communication with a response device which responds to an address request for requesting a physical address, the response device being connected to a communication circuit that is the same as a communication circuit to which an information processing device is connected;
controlling power supply of the information processing device, based on a first mode or a second mode which requires a smaller power consumption than the first mode; and
requesting, in a case where the information processing device is shifted from the first mode to the second mode, the response device to respond with a physical address assigned to the information processing device to the address request whose destination address is equal to a logical address in the communication circuit assigned to the information processing device.

13. A non-transitory computer readable medium storing a program causing a computer to execute a response process, the process comprising:
storing a logical address and a physical address in a communication circuit which are assigned to an external information processing device connected to the communication circuit that is the same as a communication circuit to which a response device is connected;
receiving an address request for requesting a physical address from the communication circuit; and
responding with the stored physical address of the information processing device in a case where a destination address of the received address request is equal to the stored logical address of the information processing device.

14. A non-transitory computer readable medium storing a program causing a computer to execute an information process, the process comprising:
controlling communication with a response device which responds to an address request for requesting a physical address, the response device being connected to a communication circuit that is the same as a communication circuit to which an information processing device is connected;
controlling power supply of the information processing device, based on a first mode or a second mode which requires a smaller power consumption than the first mode; and
requesting, in a case where the information processing device is shifted from the first mode to the second mode, the response device to respond with a physical address assigned to the information processing device to the address request whose destination address is equal to a logical address in the communication circuit assigned to the information processing device.
